(19) United States
(12) Patent Application Publication
(10) Pub. No.: US 2005/0144069 A1
(43) Pub. Date: Jun. 30, 2005

(54) Method and system for providing targeted graphical advertisements

(76) Inventors: Leora Ruth Wiseman, Sunnyvale, CA (US); Sumit Agarwal, San Carlos, CA (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(21) Appl. No.: 10/742,791

(22) Filed: Dec. 23, 2003

(51) Int. Cl. G06F 17/60

(52) U.S. Cl. 705/14

(57) ABSTRACT

A system and a method are directed to targeted graphical advertisements, which may involve identifying a graphical advertisement associated with an entity (e.g., advertiser); associating one or more concepts with the graphical advertisement; receiving a request for an advertisement associated with a concept; and delivering the graphical advertisement associated with the concept, wherein the graphical advertisement is positioned for display based on a ranking among advertisements for the concept, the ranking being based at least on a price parameter amount offered by the entity.

### FIELD OF THE INVENTION

The present inventions relate generally to providing targeted advertisements, and more particularly to, a method and system for providing targeted graphical advertisements associated with one or more content-based concepts, such as keywords and subject matters of interest.

### BACKGROUND OF THE INVENTION

Advertising using traditional media, such as television, radio, newspapers and magazines, is well known. Unfortunately, even armed with demographic studies and entirely reasonable assumptions about the typical audience of various media outlets, advertisers recognize that much of their advertisement budget is simply wasted. Moreover, it is difficult to identify and eliminate such waste.

With the advent of the Internet, advertising over more interactive media has become popular. Advertisers have developed several strategies in an attempt to maximize the value of such advertising. For example, advertisers may place advertisements on home pages of various web sites (e.g., news web sites, search engines, etc.). In another example, an advertiser may attempt to target advertisement to a more narrow audience, thereby increasing the likelihood of a positive response by the audience. For example, a hotel in Las Vegas may promote special discounts on a travel website, specifically on the web pages directed to Vegas vacations. Generally, an advertiser will determine such targeting manually.

Website-based advertisements are often presented to their advertising audience in the form of “banner ads”—i.e., a rectangular box that includes a graphic. Oftentimes, the graphic is animated to attract the audience's attention. When a member of the advertising audience selects one of these banner ads by clicking on it, embedded hypertext links typically direct the viewer to the advertiser's website. This process, wherein the viewer selects an advertisement, is commonly referred to as a “click through,” and may be used to refer to any type of user selection. The ratio of the number of click throughs to the number of impressions of the advertisement (i.e., the number of times an advertisement is displayed) is commonly referred to as the click through rate of the advertisement.

Despite the initial promise of website-based advertisements, there remain several problems with existing approaches. Although advertisers are able to reach a large audience, they are frequently dissatisfied with the return on their advertisement investment. As the advertisements are oftentimes overly general or specific, most end-users are bombarded with irrelevant and sometimes annoying advertisements that are of little value. Regardless of how animated and colorful the graphic may be, an end-user will generally not be interested in the service or product behind the graphic if it is of little or no relevance to the end-user's needs.

These and other drawbacks exist with current systems and methods.

### SUMMARY OF THE INVENTION

Accordingly, various embodiments of the present inventions may be directed to a system and a method for providing targeted graphical advertisements based on content-based concepts (e.g., keywords selected by an advertiser, subject matter, other terms associated with a concept, etc.).

In one exemplary embodiment, a system and a method are directed to targeted graphical advertisements, which may involve identifying a graphical advertisement associated with an entity (e.g., advertiser) where one or more concepts may be associated with the graphical advertisement. A request for an advertisement associated with a concept may be received at a server or other location. In response, the graphical advertisement associated with the concept may be delivered to be viewed by end-users, wherein the graphical advertisement is positioned for display based on a ranking among advertisements for the concept, the ranking being based at least on a price parameter amount offered by the entity.

### BRIEF DESCRIPTION OF THE DRAWINGS

FIG. 1 is a flowchart illustrating a method for creating targeted graphical advertisement with content-based concepts according to an embodiment of the present invention.

FIG. 2 is a flowchart illustrating a method for providing targeted graphical advertisement with content-based concepts according to an embodiment of the present invention.

FIG. 3 is a flowchart illustrating a method for ranking targeted graphical advertisements according to an embodiment of the present invention.

FIG. 4 is a schematic of a system for providing targeted graphical advertisements according to an embodiment of the present invention.

FIG. 5 is an exemplary interface for viewing data associated with targeted graphical advertisements according to an embodiment of the present invention.

FIG. 6 is an exemplary search page with targeted graphical advertisements according to an embodiment of the present invention.

### DETAILED DESCRIPTION OF EXEMPLARY EMBODIMENT(S)

An embodiment of the present invention provides for uploading graphics, scaling the graphics to fit a desired size and associating the graphics with content-based concepts (e.g., keywords, subject matter, etc.) that relate to a service or product associated with the graphic. When the concepts trigger relevant content or search results, the graphics may be displayed based on a rank. For example, the graphics may be ranked based on relevancy, performance parameter (e.g., click through rate, conversion rate, performance information, other measure of performance, etc.), price parameter (e.g., an amount an advertiser is willing to pay for each click, bid amount, price information, other measure of price, etc.), and/or other factors. Graphical advertisements may be targeted to search results and/or content pages (e.g., web pages, emails, print media, etc.) on a wide variety of sites and other display environments.

Generally, web site providers make advertising space available on their sites as a source of revenue because in most cases end-users view the web site pages without payment. The more the end-user is interested in an advertisement, the more likely the end-user will be to click on (or otherwise select) the advertisement. By clicking on (or selecting) the advertisement, the end-user obtains more information about the product or service being offered and will more likely become a customer. To be competitive, advertising web sites need to increase the number of times an end-user clicks (or selects) an advertisement relative to the number of impressions the advertisement gets on the site. This statistic may be referred to as a click through rate (CTR). By increasing the CTR, advertisers will be more inclined to advertise on these web sites.

An advertiser may increase the CTR associated with its advertisements by displaying graphical advertisements (e.g., including images, animations, movies, etc.) in prominent places. This has the potential of increasing the CTR, if the end-user is interested in what the advertisement is offering. Another reason web sites may prefer graphical advertisements is that some products and services may not achieve a high CTR using text advertisements alone. For example, some advertisers may be more interested in building brand recognition, which may be best served by including an image (or other graphic) of the product, the logo of the company and/or other images and graphics that make up the brand. Thus, graphical advertisements may assist in improving brand recognition due in part to increased CTR. In some instances, graphical advertisements may build brand recognition even if the advertisement is not clicked.

Content-targeted text advertisements may be displayed when the text advertisements relate to the content that the end-user is currently viewing. This is very helpful to the end-user and increases the CTR for the advertiser. An end-user is likely to become more interested in the product or service that an advertisement is promoting if the advertisement is related to the content in which the end-user has expressed interest. The content may be accessed by clicking (or other type of selecting) and viewing the content or by actively searching for it.

In one illustrative iteration of the present invention, a method and system display graphical advertisements that are related to a subject the end-user searched for or the page the end-user is currently viewing. Specifically, advertisers may purchase content-based concepts, such as keywords, in some fashion and associate a graphical advertisement with the concepts so that the advertisements may be displayed in connection with relevant content thereby increasing the CTR or other performance parameter. In another example, advertisers may associate graphical advertisements with content pages, identified by content-based concepts. For example, an advertiser may want to associate a graphical advertisement with a subject matter, e.g., baseball, where the resulting content pages may not necessarily have the term “baseball” located anywhere on the content page. Therefore, content-based concepts may refer to search term matches as well as concept or subject matter matches, not limited to mere word matches.

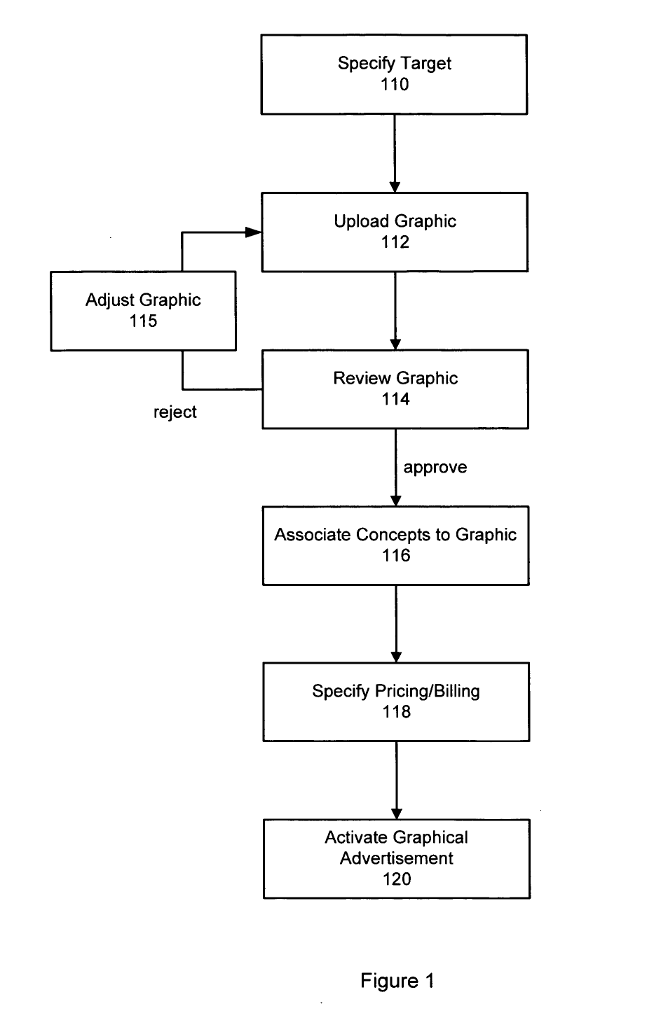

FIG. 1 is a flowchart illustrating a method for creating targeted graphical advertisement with content-based concepts according to an embodiment of the present invention. At step 110, an advertiser may specify a potential target audience. This step may be optional. For example, the advertiser may specify a target language and/or target countries. In addition, the advertiser may target a type of customer based on demographic and/or other data. Further, the advertiser may intend the graphical advertisement to be displayed on content pages, results of search pages and/or other types of display. Content pages may refer to any page that contains content, including web pages, emails, print material or other media. For example, advertisements directed to children may be restricted from display on adult sites or sites that promote violence. The advertiser may selectively choose whether to allow the advertisement to be displayed on syndication sites. Syndication sites may refer to third party websites that receive advertisements from the provider for a compensation. In addition, the advertiser may be asked and/or required to accept a contract that would free the server from copyright restrictions associated with storing and displaying a copy of the graphic (e.g., logo, trademark, etc.).

An advertiser may represent an entity providing a service and/or product. The advertiser may also represent an advertising agent or other entity acting on behalf of the advertiser. The advertiser may be a commercial, private, non-profit, government or other type of entity.

At step 112, the advertiser may identify and upload a graphic. The graphic may include an image, animation, design, logo, picture and/or any other visual or audio display. The graphic may be uploaded by the advertiser entering an associated address, e.g., URL, for the graphic. In addition, the graphic may include additional display options, such as ability to expand (e.g., to a part of the page, the entire page, etc.), animation, sound (e.g., music, dialog, etc.), pop-up ability, and/or other display options. For example, a graphic may expand to a larger and/or different graphic when a cursor hovers over the graphic.

At step 114, the advertiser may then review the graphic. If the advertiser approves the graphic, the graphic may be accepted. For example, the advertiser may verify that the activated audio and/or display options function correctly. The advertiser may reject the graphic, make modifications or use a different graphic, at step 115. The graphic may be reloaded at step 112 and further reviewed by the advertiser at step 114.

At step 116, one or more content-based concepts (e.g., keywords, subject matter, etc.) may be associated with the graphic. For example, the advertiser may identify one or more keywords, which would trigger a display of the graphical advertisement. By specifying concepts, the graphical advertisement will be displayed when an end-user expresses interest in subject matter associated with the concepts. For example, a food delivery service may select keywords such as “food” and “delivery” thereby increasing the likelihood of display of a relevant graphical advertisement. When an end-user is searching for web pages associated with “food” and “delivery,” a graphical advertisement associated with the food delivery service may be displayed. Additional groups of keywords may be applied as well. The same food delivery service may select additional groups of concepts to include other keywords, such as “grocery” and “deliver” and may also include another group, which may include a key phrase, such as “food delivery service in Baltimore area.”

In another example, the advertiser may select from a group of potential keywords. For example, a server may automatically extract keywords from the advertiser's website or other designated web page or other location. A list of potential keywords may be displayed for the advertiser to select from. Other methods for associating concepts (e.g., keywords, subject matter, etc.) with a graphic may be implemented.

In another example, an advertiser may specify content-based concepts directed to a subject matter. For example, an advertiser for car repair service may want to display a graphical advertisement on web pages directed to car repair where the terms “car” and “repair” may or may not appear in the content pages.

In another example, one or more graphical advertisements may be associated with an ad group involving a group of advertisements. For example, the group of advertisements may include non-graphical, text-only or other advertisements associated with the same (or related) advertiser that created the graphical advertisement. Other methods for grouping advertisements may be applied. This ad group may be triggered using common criteria (e.g., the same (or related) keywords, subject matter or concepts, etc.). An advertiser may use a single interface to manage various advertisements (e.g., text-only advertisements, graphical advertisements, other rich media advertisements including audio and/or visual information, and other advertisements). Additional examples of managing online advertising by associating two or more keywords with an advertisement and associating a bid, collectively, with the two or more keywords are discussed in U.S. patent application Ser. No. 10/340,193, filed on Jan. 10, 2003, entitled “Pricing Across Keywords Associated with One or More Advertisements,” which is incorporated by reference herein in its entirety.

At step 118, the advertiser may specify pricing/billing data. For example, the advertiser may specify a price parameter, such as cost per click (“CPC”) amount, bid amount or other amount offered by the advertiser. The price parameter may represent an amount that the advertiser is willing to pay each time the graphical advertisement is clicked (or otherwise selected). The advertiser may specify a maximum cost per click amount as well as a daily budget. The daily budget may represent how much an advertiser wants to spend per month (or other time frame) divided by the number of days in that month (or other time frame). The server may use this data to match a daily amount to help ensure maximum advertisement exposure evenly throughout each day (or other time period). Additional examples of governing the serving (or delivery) of advertisements based on some cost target, such as cost budget for a given period of time, are discussed in U.S. patent application Ser. No. 10/340,553, filed on Jan. 10, 2003, entitled “Governing the Serving of Advertisements Based on a Cost Target,” which is incorporated by reference herein in its entirety. Advertisers may budget their advertising expenditures, while allowing an ad serving entity to maximize its revenue subject to advertisers' budget constraint(s). For example, an exemplary embodiment may estimate an expected cost if an ad were subject to no budgetary constraints and govern the serving of the advertisement based on the expected cost and the budget constraint(s).

Certain days or time frames may be targeted for increased exposure. For example, during the holiday season, an advertiser may be willing to spend more on advertisement to increase exposure. In addition, peak Internet usage times may also trigger additional advertisement exposure. Additional examples of determining and using time information (e.g., end user local time information, including local time-of-day, local day-of-week, local date, and/or local season information, etc.) for improving usefulness and performance of advertisements are discussed in U.S. patent application Ser. No. 10/676,369, filed on Oct. 1, 2003, entitled “Determining and/or Using End User Local Time Information in an Ad System,” which is incorporated by reference herein in its entirety.

An advertiser may specify content-based concepts (e.g., keywords, subject matter, etc.) and a price parameter (e.g., a maximum amount an advertiser is willing to pay for each click) where the advertiser pays only when an end-user clicks on the graphical advertisement. Additional costs may be saved by automatically reducing the actual CPC to a lowest cost needed to maintain the graphical advertisement's position on the results page (e.g., content page, search results page, etc.). Additional examples of presenting advertisements and managing advertising costs are discussed in U.S. patent application Ser. No. 10/340,543, filed on Jan. 10, 2003, entitled “Automated Price Maintenance for Use With a System in which Advertisements are Rendered with Relative Preferences” and U.S. patent application Ser. No. 10/340,542, filed Jan. 10, 2003, entitled “Automated Price Maintenance for Use With a System in Which Advertisements are Rendered with Relative Preference Based on Performance Information and Price Information,” which are incorporated by reference herein in their entirety. Advertisements may be ordered based on accepted maximum ad bid information, or a combination of maximum ad bid information and ad performance information. For example, this information may be used to determine a position (or some other ad preference) value. Cost may be determined based on the accepted maximum ad bid information and the next lower position value.

At step 120, a graphical advertisement may be activated. The advertiser may also establish an account through which the advertiser may make modifications to pricing/billing data as well as modifications to the graphic, content-based concepts (e.g., keywords, subject matter, etc.) and/or other input data. Modifications may involve adding, deleting, and/or changing various aspects of the graphical advertisement.

According to another iteration of the present invention, graphical advertisements may be combined with text, including text advertisements, and/or other displays.

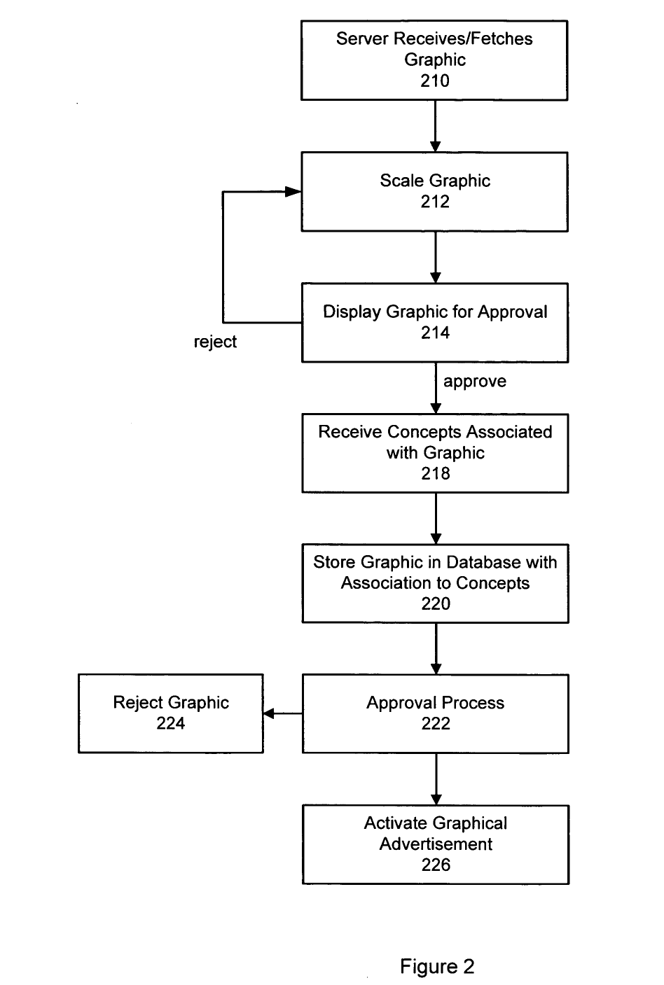

FIG. 2 is a flowchart illustrating a method for providing targeted graphical advertisement with content-based concepts according to an embodiment of the present invention. At step 210, a server may receive or fetch a graphic associated with an advertiser. The server may receive the graphic uploaded by the advertiser, where the uploading may be performed in a variety of ways. In addition, the server may fetch the graphic from an identified address or location. For example, the graphic may be downloaded from a specific web site, such as the advertiser's site or other location. Graphics may also be transmitted through an electronic transmission, e.g., email. In another example, graphics may be retrieved by crawling and downloading a specific page of graphics and/or keywords on an advertiser's site or other location, which may then be uploaded to a database.

At step 212, the server may scale the graphic to fit a predetermined size or shape (e.g., fill a rectangle of uniform size with the graphic). Graphics may be scaled to different sizes. For example, certain graphics may be sized or shaped differently based on an advertiser's willingness to pay an additional amount (or other incentive or credit). Also, for different display environments, the graphic may be sized based on the available space. For example, for a content page, the graphic may be intended for placement on a different size or shape than a search result page. Other environments for display may be considered.

At step 214, the scaled graphic may be displayed to the advertiser for approval. If the scaled graphic is rejected, the graphic may be adjusted. For example, the scaling process may distort the graphic or scale the graphic to a size unacceptable to the advertiser. Otherwise, the advertiser may accept the scaled graphic.

At step 218, one or more content-based concepts may be associated with the graphic. Concepts may be identified or associated before or after the graphic is uploaded. The advertiser may provide the keywords to be associated with the graphic. Concepts may be words or terms that may trigger a display of the graphic in association with a content page, a search result page or other page. In another example, a server may automatically extract keywords from the advertiser's website or other designated web page or location. A list of potential keywords may be displayed for the advertiser to select from. In addition, an advertiser may specify a concept, which may include a subject matter and not necessarily words found within a content page. Other methods for associating concepts (e.g., keywords, subject matter, etc.) with a graphic may be implemented.

At step 220, the graphic may be stored in a database. The graphic may be associated with the one or more concepts, where the concepts may be stored with the graphic or in a separate database. In addition, the graphic may be associated with multiple groups of concepts.

At step 222, the graphic may be approved by the server. The approval process may check for offensive or other inappropriate material (e.g., nudity, violent images, etc.), which may be approved automatically. In addition, the approval process may include approving content and verifying relevancy to the advertisement, which may be a manual or automated process. If the graphic fails to pass the approval process, the graphic is rejected at step 224. If the graphic is approved, a graphical advertisement may be activated at step 226.

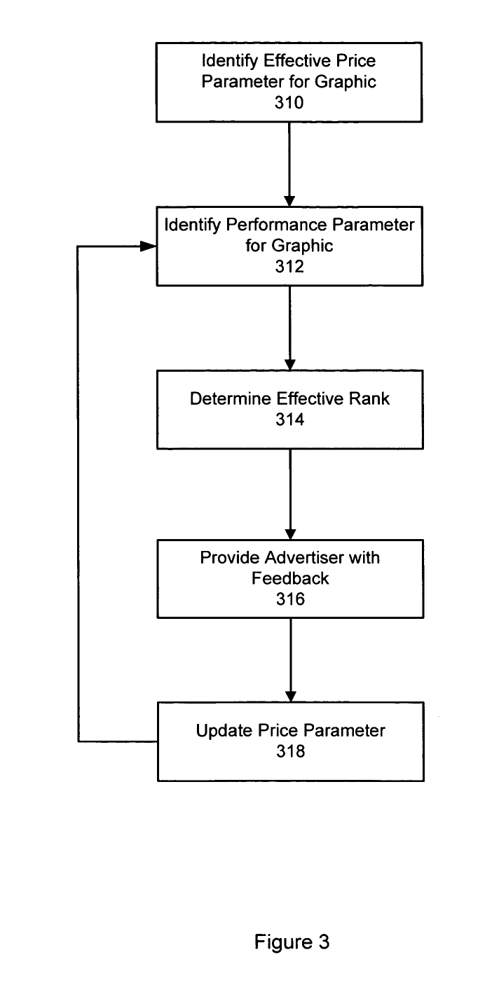

FIG. 3 is a flowchart illustrating a method for ranking targeted graphical advertisements according to an embodiment of the present invention. FIG. 3 illustrates an exemplary ranking method. Other ranking methods may be applied. At step 310, a price parameter (e.g., a cost per click amount, etc.) may be identified for a graphic. The price parameter may be based on a maximum amount an advertiser is willing to pay for each click. At step 312, a performance parameter (e.g., a click through rate, conversion rate, etc.) may be identified for the graphic. For example, the click through rate may represent a number of clicks divided by a number of impressions where the impressions represent each time the graphic appears on a page (e.g., a content page, a search result page, etc.) for display to an end-user. The click through rate may be based on historical data and may be updated after a predetermined passage of time (e.g., each hour, each day, etc.) and/or may be updated after a predetermined number of clicks (e.g., each click, every 3 clicks, every 10 clicks, etc.) or impressions. Other price parameters and/or performance parameters may be implemented.

At step 314, an effective rank of the graphic may be determined. The effective rank may be based on the price parameter (e.g., the cost per click, etc.) and the performance parameter (e.g., click through rate, etc.). According to an example, the effective rank may be determined by multiplying the cost per click and the click through rate. In one example, a higher graphical advertisement's CPC or CTR results in a higher graphical advertisement position. Because this ranking system rewards well-targeted, relevant advertisements, an advertiser cannot be locked out of the top position as an advertiser would in a ranking system based solely on price. If an advertisement is irrelevant, end-users are less likely to click on the advertisement thereby forcing the advertisement to move down the page. Similarly, if an advertisement is relevant, it is likely to rise to the top without additional payment from the advertiser. Additional examples of ordering advertisement using scores where the scores may be determined using, at least one of accepted advertisement price information and advertisement performance information are discussed in U.S. patent application Ser. No. 10/445,376, filed on May 23, 2003, entitled “Scoring, Modifying Scores of, and/or Filtering Advertisements Using Advertiser Information,” which is incorporated by reference herein in its entirety. The score may be determined (or adjusted) using, at least, advertiser information. In addition, advertiser information may be used to filter out advertisements. Additional examples of ordering advertisements in a manner that maximizes relevance and economic values are discussed in U.S. patent application Ser. No. 10/112,656, filed on Mar. 29, 2002, entitled “Methods and Apparatus for Ordering Advertisements Based on Performance Information” and U.S. patent application Ser. No. 10/112,654, filed on Mar. 29, 2002, entitled “Methods and Apparatus for Ordering Advertisements Based on Performance Information and Price Information,” which are incorporated by reference herein in their entirety. Advertisement ordering may be based on accepted advertisement price information and/or advertisement performance information where price information and/or performance information may be weighted or otherwise adjusted.

Various modifications may be applied to ranking graphical advertisements as well as other advertisements. For example, a premium (or negative discount or other incentive or disincentive, etc.) may be applied for advertisements of various qualities and types. For example, a graphical advertisement with enhancements (e.g., graphical/richer media advertisements, animation, sound, etc.) may be charged an adjusted CPC, CTR or other factor. More specifically, richer media advertisements may be charged a higher rate on the theory these types of advertisements are better in quality. Conversely, such advertisements may be charged a reduced rate to encourage advertisers to create graphical advertisements or other richer media advertisements. In an exemplary ranking mechanism that involves calculating an effective rank by combining a CPC value with a CTR value, an adjustment may be made to the CTR and/or the CPC. For example, the CTR may be adjusted by applying an adjustment to the CTR to effectively increase the CTR value for graphical advertisements (or other media rich advertisement). In another example, the CPC may be adjusted by adding an adjustment (fixed or variable) amount to the CPC. In addition, both price parameter and performance parameter may be adjusted. For example, if a maximum CPC is $0.20 for a certain advertisement, an adjustment of $0.05 may be added based on advertisement type (e.g., graphical advertisement, enhancements, etc.). Similarly, different advertisement types may be assigned varying values of adjustment. For example, for a graphical advertisement, an adjustment of $0.05 may be applied while an adjustment of an additional $0.10 may be applied if the graphical advertisement includes animation. Various increments and other considerations may be implemented.

In addition, when a maximum CPC (or other price parameter) is selected for concepts, an estimated average advertisement position per concept (e.g., keyword) may be provided where the estimate may be based on a maximum CPC and an average CTR for each of the concepts selected by the advertiser.

Some sites may have a limited amount of advertisement space, thereby restricting the number of advertisements for display. For example, some sites may only allow 3 advertisements per page. Depending on the size and type of advertisement, additional restrictions may be placed. For example, some sites may only allow two text advertisements and one graphical advertisement.

At step 316, feedback data may be provided to the advertiser through a display. For example, the advertiser may view how the graphic is ranked, along with the click through rate and/or other performance parameter. Based on the performance of the graphic, the advertiser may modify the price parameter (e.g., cost per click), at step 318, and/or other factors associated with the graphic.

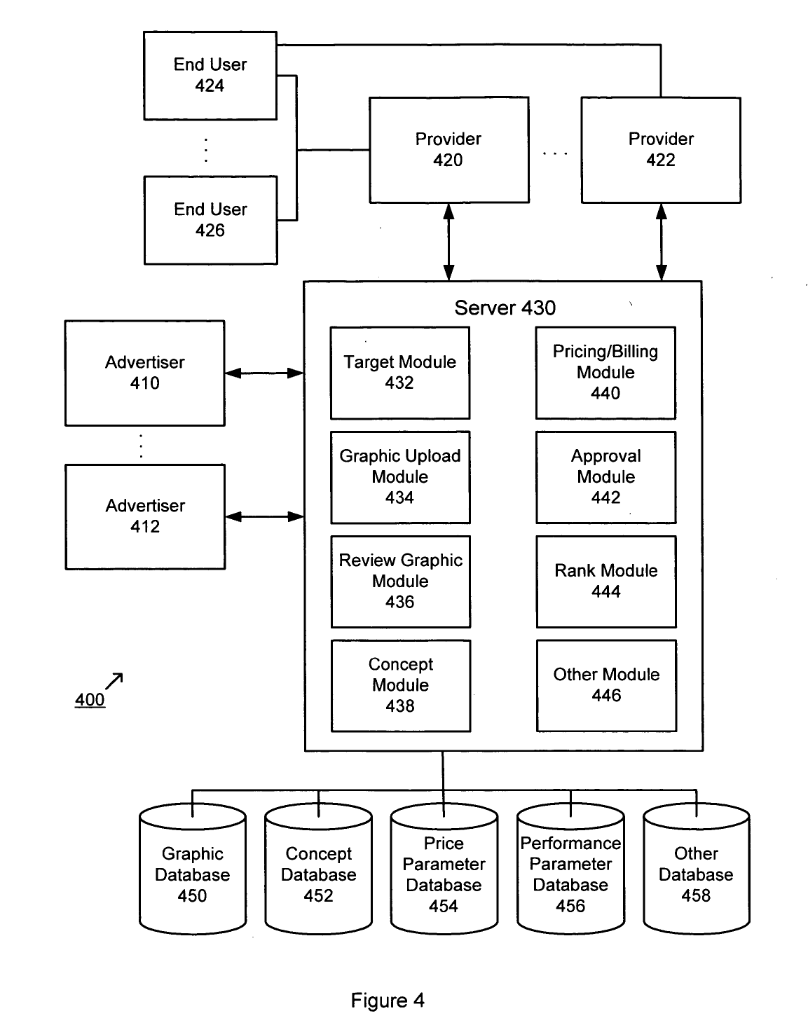

FIG. 4 is a schematic of a system for providing targeted graphical advertisements according to an embodiment of the present invention. System 400 enables an advertiser to create graphics and associate the graphics with content-based concepts for triggering targeted display of the graphical advertisements. Advertisers 410, 412 may communicate with Server 430 via electronic communication, including Internet communications. Providers 420, 422 may include Server 430 for providing functionality associated with targeted graphical advertisements. Providers 420, 422 may operate separately or in combination with Server 430. Providers 420, 422 may provide content pages, search results and/or other types of pages to one or more end-users, illustrated by 424 and 426. Providers 420, 422 may represent any content provider, search engine or other entity that makes available information, services, and products over an electronic network, such as the Internet. Additional participants may be included based on various applications. For example, multiple advertisers, providers and end-users as well as multiple servers, modules and databases may be implemented.

Server 430 may include various modules for providing functionality associated with targeted graphical advertisements, including Target Module 432, Graphic Upload Module 434, Review Graphic Module 436, Concept Module 438, Pricing/Billing Module 440, Approval Module 442, Rank Module 444 and other module 446. The modules may function separately or in various combinations. While the modules are shown within a single server, the modules may also operate among several servers. The modules may communicate with a plurality of databases, which may also function collectively or separately. Databases may include Graphic Database 450, Concept Database 452, Price Parameter Database 454, Performance Parameter Database 456 and other database 458.

For example, Server 430 may receive a request from Provider 420, 422 (or other requester) for an advertisement associated with a concept (e.g., keywords, subject matter, etc.). In response to the request, the server may deliver a graphical advertisement associated with the concept where the graphical advertisement is positioned for display based on a ranking among advertisements for the concept.

Target Module 432 enables an advertiser (e.g., 410, 412) to specify a target intended audience. For example, the advertiser may specify a preferred language, country or other demographic preference. The advertiser may want to reach potential customers through a content page, search results page and/or other type of page. The advertiser may also specify if the graphic will be displayed on syndicated sites. In addition, the advertiser may not specify any target audience or any limitation.

Graphic Upload Module 434 enables an advertiser to upload a graphic. The graphic may be uploaded by identifying an address (e.g., URL address, etc.). The graphic may be downloaded from the advertiser's website or other associated site. The graphic may be retrieved from a database or other source. The graphic may include various visual options, including animation, pop-up ability, sound waves, etc. and may also include text, including text advertisement. The server may size or shape the graphic to fit a predetermined size or shape. In addition, the advertiser may select from a selection of sizes and/or shapes for display. For example, the advertiser may be willing to pay more for a larger size graphic rather than settle for a smaller standard size. By enlarging the graphics, an advertiser may increase potential click through by end-users.

Review Graphic Module 436 enables an advertiser to review a graphic after the graphic has been scaled to fit a predetermined space or size. The advertiser may approve the graphic, make additional modifications or simply identify and upload a new graphic.

Concept Module 438 enables an advertiser to identify one or more content-based concepts (e.g., keywords, subject matter, etc.) for association with the uploaded graphic. For example, the advertiser may identify multiple groups of concepts. The concepts may be used to target the graphics to improve potential click through rate. For a search result page, if the search terms entered by an end-user substantially match the concepts (e.g., keywords), an associated graphic may be displayed on a search result page based on a rank. For a content page, if the content page matches the concepts (e.g., subject matter), an associated graphic may be displayed on a content page based on a rank. In addition, an advertiser's web site (or other associated or identified site) may be accessed to retrieve terms and/or phrases throughout the sites or designated pages to formulate a list of potential keywords and/or subject matter selections. The advertiser may select keywords and/or identify relevant subject matter from the list.

Pricing/Billing Module 440 enables an advertiser to specify cost data and/or other price parameter. For example, an advertiser may specify a maximum price the advertiser is willing to pay for each time the graphic is clicked. For example, the advertiser may specify a daily budget. The advertiser may also make modifications to the cost data.

Approval Module 442 may review the graphic for offensive and/or inappropriate material as well as relevancy. For example, the graphic may be reviewed for nudity, violent images (e.g., guns, etc.), and other offensive images and/or graphics. The review process may also be tied to an intended audience, such as children, young teens, etc., where sensitive graphics and/or images may be more closely scrutinized. This review process may be automatic. In addition, the graphics may be reviewed for relevancy to the advertiser or intended advertisement as well as the keywords and concept targeting. This aspect of the review process may be manually or automatically performed to ensure that relevant graphics are displayed in connection with content pages, search result pages and/or other pages. Rank Module 444 may determine a rank of the graphic. The rank of the graphic may refer to the placement of the graphic. Generally, the higher (or more prominently) the graphic is displayed, the more likely an end-user will be to take notice, thereby improving the potential for a click through (e.g., an end-user clicking on the graphic). According to one example, the ranking of the graphic may be determined by multiplying the cost per click and the click through rate. Other methodologies for ranking graphics may be implemented. For example, other price parameters and/or performance parameters may be considered.

Based on differences in customer behavior, the performance parameter for content pages and search pages may be different. Other adjustments may be applied for different types of pages.

An auction process for determining which advertisement to show in which placement may become more complicated as the pricing for graphical advertisements may have a premium associated with the display. For example, placement of advertisements may be based on a click through rate and cost per click (e.g., bid amount or any amount offered by an advertiser) combination (e.g., CTR * CPC). For a graphical advertisement, the cost per click amounts may be different for different types of graphics and also in relation to text advertisements. In another example, the CTR value for graphical advertisements may be adjusted by an amount or a variation of the CTR. A different ranking function, such as CTR′ * CPC may be implemented, where CTR′ may represent an adjusted CTR for graphical advertisements (or types of graphical advertisements). In another example, a ranking function may involve CTR * CPC/z where z may represent a function of the graphical advertisement type. Other variations and adjustments may be implemented. Graphical advertisement type may include a variety of considerations, such as size, animation, color, sound, voice, visual options (e.g., pop-up ability, etc.), type of product or service, images used, or other characteristic associated with the graphic.

During the process of ranking the graphics, there may be instances where the graphic may be ranked with other graphics as well as other text advertisements. In ranking graphics with text advertisements, an adjustment may be applied. For example, a graphical advertisement may occupy more space than a text advertisement. In addition, a graphic may be considered more likely to be clicked on. Thus, an adjustment may be applied when compared to text advertisements. In another example, advertisers may be charged a higher rate for graphical advertisements based on a higher likelihood that the advertisement will be selected. Further, additional costs may be associated for additional enhancements (e.g., animation, sound, music, size, shape, etc.) or other features that may increase the advertisement's likelihood of being selected. In yet another example, to encourage the use of graphical advertisements, a provider may offer an incentive (e.g., credit, compensation, etc.) to an advertiser for displaying graphical advertisements. Additional incentives may be provided for additional enhancements to the graphical advertisements.

In addition, Rank Module 444 may also determine a position for the graphical advertisement. Some advertisements may be displayed as a banner, across the top of a page (e.g., search page, content page, etc.), along the side of search results, and anywhere else on the page.

The modules of Server 430 may store, access and otherwise interact with various sources of data, including external data, databases and other inputs. Graphic Database 450 may store graphics, including images, animations sound files, and/or other display options, associated with various advertisers and/or other entities. Concept Database 452 may store one or more concepts (e.g., keywords, subject matter, etc.) and multiple groups of concepts (e.g., keywords, subject matter, etc.) that may be associated with a graphic and/or advertiser. Price Parameter Database 454 may store data associated with cost per click (or other price parameter), including bid amounts, for each graphic and/or advertiser. Performance Parameter Database 456 may store data associated with click through rate (or other performance parameter) for each graphic and/or advertiser.

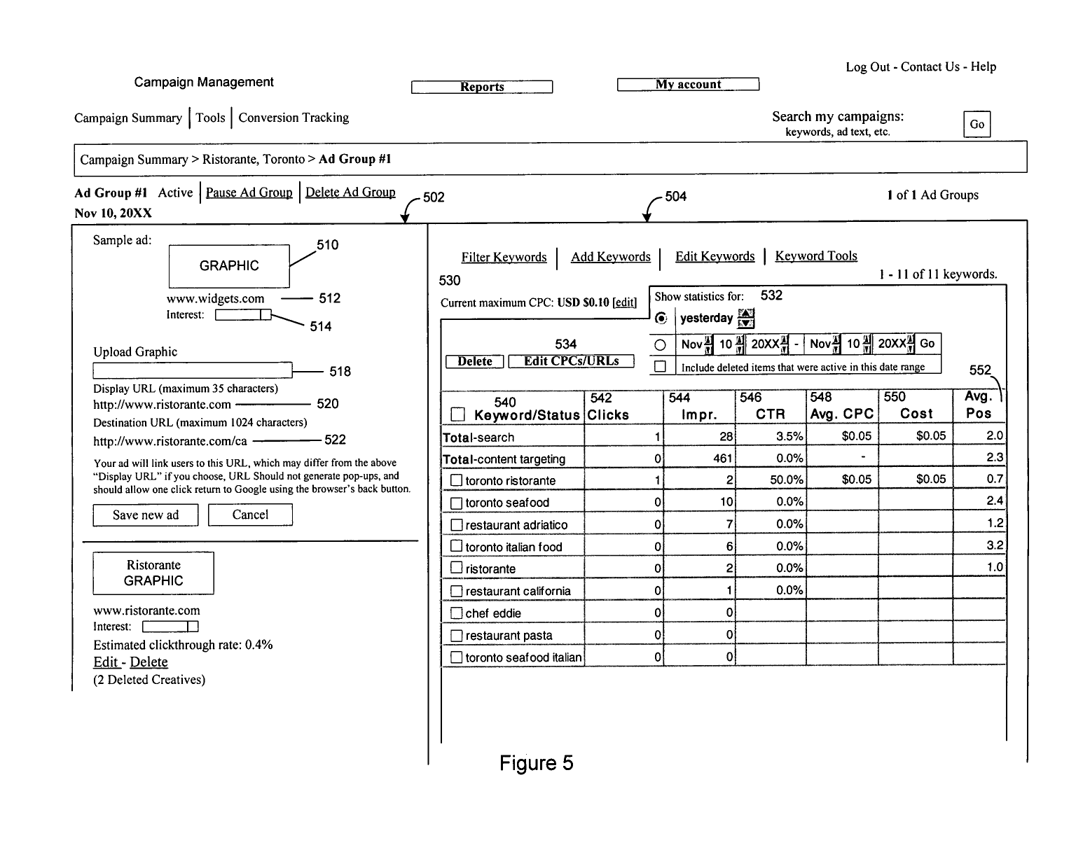

FIG. 5 is an exemplary interface for viewing data associated with targeted graphical advertisements according to an embodiment of the present invention. Another illustrative iteration of the present invention provides an interface for creating, editing, tracking and performing other actions associated with targeted graphical advertisements. An advertiser or other authorized entity may generate reports on past performance as well as projected performance. The advertiser may manage an account for tracking targeted graphical advertisements. In addition, an advertiser may monitor which concepts or group of concepts are performing well.

An advertiser may create a targeted graphical advertisement at 502. A graphic may be uploaded at 518, by identifying an address or by other mechanism for identifying a graphic. An associated display URL may be entered at 520. The advertiser may also have an option to hide the URL when the graphical advertisement is displayed. A destination URL may be specified at 522. The destination URL may represent the web page the end-user will be directed to when the graphic is clicked on, or otherwise activated. The graphical advertisement may be displayed and reviewed where the advertiser may edit, delete or perform other actions.

At 504, an advertiser may view performance data associated with one or more graphics. In addition, the advertiser may add keywords, edit keywords and delete keywords, for example. In another example, another content-based concept, such as subject matter, may also be displayed. A maximum current cost per click may be displayed at 530. Cost per click data may be edited at 534. At 532, a time frame may be specified. An advertiser may view keywords at 540, clicks 542, impressions 544, click through rate 546, average cost per click 548, cost 550, and average position 552. Underperforming keywords may be disabled or flagged for the advertiser based on a click through rate falling below a threshold minimum. Other performance data may be displayed.

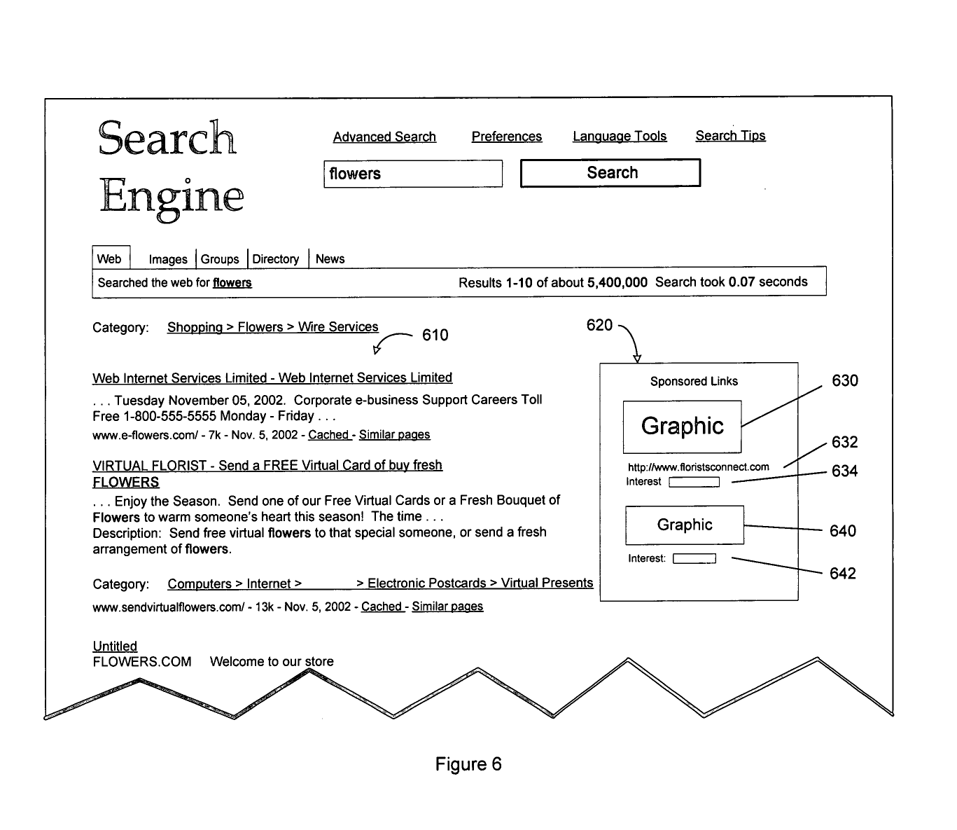

FIG. 6 is an exemplary search page with targeted graphical advertisements according to an embodiment of the present invention. A search results page may include a plurality of search results 610 ranked by order of relevancy. Graphical advertisements 630 may include a display URL 632 along with an interest level 634. Another graphic 640 may have a hidden URL along with an interest level 642.

The embodiments of the present inventions are not to be limited in scope by the specific embodiments described herein. For example, although many of the embodiments disclosed herein have been described with reference to clicks and costs per click, the principles herein are equally applicable to other performance criteria, such as for example user conversions and costs per conversions. Indeed, various modifications of the embodiments of the present inventions, in addition to those described herein, will be apparent to those of ordinary skill in the art from the foregoing description and accompanying drawings. Thus, such modifications are intended to fall within the scope of the following appended claims. Further, although the embodiments of the present inventions have been described herein in the context of a particular implementation in a particular environment for a particular purpose, those of ordinary skill in the art will recognize that its usefulness is not limited thereto and that the embodiments of the present inventions can be beneficially implemented in any number of environments for any number of purposes. Accordingly, the claims set forth below should be construed in view of the full breath and spirit of the embodiments of the present inventions as disclosed herein.

1. A method for providing targeted graphical advertisements, the method comprising the steps of:
identifying a graphical advertisement associated with an entity;
associating one or more concepts with the graphical advertisement;
receiving a request for an advertisement associated with a concept; and
delivering the graphical advertisement associated with the concept, wherein the graphical advertisement is positioned for display based on a ranking among advertisements for the concept, the ranking being based at least on a price parameter offered by the entity.

2. The method of claim 1, further comprising the step of:
scaling the graphical advertisement to a predetermined size or shape for display.

3. The method of claim 1, further comprising the step of:
approving the graphical advertisement for display for offensive material and for relevancy to the concept with which the graphical advertisement has been associated.

4. The method of claim 3, wherein the review for offensive material is performed automatically.

5. The method of claim 3, wherein the review for relevancy is performed manually to determine whether the one or more concepts are relevant to the graphical advertisement.

6. The method of claim 1, wherein the price parameter comprises a cost per click amount.

7. The method of claim 1, wherein the ranking is further based at least on a performance parameter associated with the graphical advertisement.

8. The method of claim 7, wherein the performance parameter comprises a click through rate.

9. The method of claim 7, wherein the performance parameter is automatically adjusted based on one or more of predetermined time passed and predetermined number of clicks.

10. The method of claim 7, wherein the ranking is calculated by multiplying the price parameter and the performance parameter.

11. The method of claim 7, wherein one or more of the price parameter and the performance parameter is adjusted based on a type of graphical advertisement.

12. The method of claim 1, wherein the graphical advertisement is displayed on one or more of a content page and a search result page.

13. The method of claim 12, wherein the content page comprises one or more of web page, email and print media.

14. The method of claim 1, wherein the one or more concepts comprise at least one or more keywords entered as a search request.

15. The method of claim 1, wherein the one or more concepts comprise at least one or more subject matters of interest.

16. The method of claim 1, wherein the entity is an advertiser.

17. The method of claim 1, wherein the graphical advertisement comprises one or more of an image, animation, pop-up ability, sound, voice and music.

18. The method of claim 1, wherein the entity is offered an incentive to provide at least one graphical advertisement.

19. The method of claim 1, wherein a premium is associated with the graphical advertisement.

20. A system for providing targeted graphical advertisements, the system comprising:
a concept module for associating one or more concepts with a graphical advertisement associated with an entity; and
a server for receiving a request for an advertisement associated with a concept; and delivering the graphical advertisement associated with the concept, wherein the graphical advertisement is positioned for display based on a ranking among advertisements for the concept, the ranking being based at least on a price parameter amount offered by the entity.

21. The system of claim 20, wherein the graphical advertisement is scaled to a predetermined size or shape for display.

22. The system of claim 20, wherein the graphical advertisement is approved for display for offensive material and for relevancy to the concept with which the graphical advertisement has been associated.

23. The system of claim 22, wherein the review for offensive material is performed automatically.

24. The system of claim 22, wherein the review for relevancy is performed manually to determine whether the one or more concepts are relevant to the graphical advertisement.

25. The system of claim 20, wherein the price parameter comprises a cost per click amount.

26. The system of claim 20, wherein the ranking is further based at least on a performance parameter associated with the graphical advertisement

27. The system of claim 26, wherein the performance parameter comprises a click through rate.

28. The system of claim 26, wherein the performance parameter is automatically adjusted based on one or more of predetermined time passed and predetermined number of clicks.

29. The system of claim 26, wherein the ranking is calculated by multiplying the price parameter and the performance parameter.

30. The system of claim 26, wherein one or more of the price parameter and the performance parameter is adjusted based on a type of graphical advertisement

31. The system of claim 20, wherein the graphical advertisement is displayed on one or more of a content page and a search result page.

32. The system of claim 31, wherein the content page comprises one or more of web page, email and print media.

33. The system of claim 20, wherein the one or more concepts comprise at least one or more keywords entered as a search request.

34. The system of claim 20, wherein the one or more concepts comprise at least one or more subject matters of interest.

35. The system of claim 20, wherein the entity is an advertiser.

36. The system of claim 20, wherein the graphical advertisement comprises one or more of an image, animation, pop-up ability, sound, voice and music.

37. The system of claim 20, wherein the entity is offered an incentive to provide at least one graphical advertisement.

38. The system of claim 20, wherein a premium is associated with the graphical advertisement.

39. At least one signal embodied in at least one carrier wave for transmitting a computer program of instructions configured to be readable by at least one processor for instructing the at least one processor to execute a computer process for providing targeted graphical advertisements by performing the steps of:
identifying a graphical advertisement associated with an entity;
associating one or more concepts with the graphical advertisement;
receiving a request for an advertisement associated with a concept; and
delivering the graphical advertisement associated with the concept, wherein the graphical advertisement is positioned for display based on a ranking among advertisements for the concept, the ranking being based at least on a price parameter offered by the entity.
